(19) United States
(12) Patent Application Publication
(10) Pub. No.: US 2007/0299556 A1
(43) Pub. Date: Dec. 27, 2007

(54) Robot system and method for scrap bundling in metal smelting and refining processes

(76) Inventor: Hugo Salamanca, Santiago (CL)

Correspondence Address: Hugo Salamanca P., Av. Suecia 84, Oficina 43, Providencia, Santiago, RM, CL

(21) Appl. No.: 11/595,954

(22) Filed: Nov. 13, 2006

Related U.S. Application Data
(60) Provisional application No. 60/734,979, filed on Nov. 10, 2005.

(51) Int. Cl. G06F 19/00; G05B 19/02

(52) U.S. Cl. 700/245; 318/568.11; 901/2

(57) ABSTRACT

The scrap, which is the residual left from the anodes used, is obtained as waste material from the electrorefining process. The scrap should be bundled for commercialization purposes, and the current bundling process is performed manually, which implies high operating costs and a high physical demand from operators. Due to the above, a robot system and method have been developed for carrying out automatic scrap bundling processes through the use of robotic manipulators. The robotic system is composed mainly of an anthropomorphous robotic manipulator of at least 6 degrees of freedom, and a gripping mechanism which allows to take the scraps and assemble the bundles.

### CROSS-REFERENCE TO RELATED APPLICATIONS

This application claims the benefit of provisional patent application Ser. No. 60/734,979 filed 2005 Nov. 10 by the present inventor

### FEDERAL SPONSORED RESEARCH

Not Applicable

### SEQUENCE LISTING OR PROGRAM

Not Applicable

### BACKGROUND

1. Field of Invention

This invention relates to the use of robotic technology in mining industry to improve the working conditions of the operators, specifically in the refinery area.

2. Prior Art

Electrorefining is one of the metal purification processes in which the metal that was subjected to a conversion merger process in the converters, is now subjected to a new process consisting in electrochemically dissolving the copper anodes in a cell, composed of the copper anode, a starting copper sheet and an acid solution of copper sulphate.

Therefore, in electrorefining, the anodes from the smelting process are refined to high purity cathodes through a process of electrodeposition. Thus, by applying a continuous current the metal under concern is returned to the anode and it is deposited over the staring sheet, to be obtained by the same procedure. After the 14 days that the process lasts; an electrorefined high purity cathode of the metal under concern is obtained. The process above mentioned is used in the copper beneficiation process obtaining an electrorefined cathode with a purity level of over 99.5%.

Nevertheless, a certain amount of the anodes can not be refined and stays as residual in the cells. These remaining anodes are called scrap and are removed from the cells by a bridge crane and moved to the loading yard. In this place, the operators arrange the scrap in bundles for commercialization.

The current procedure for scrap bundling requires a great number of operators, which implies high operating costs. Similarly, the operators are exposed to a high physical demand due to the weight of the scrap, which reaches 70 kg approximately.

One of the major disadvantages of the tasks associated to scrap bundling is the exposure of the personnel to harsh environmental conditions. This, in the medium and long term, could generate serious occupational diseases to the people in charge of carrying out these tasks

### SUMMARY

A robotic system and a robotized method have been developed for scrap bundling in metal smelting and refining processes to carry out in automatic way. Avoid the exposure of the personnel to harsh environmental conditions.

### DRAWINGS—FIGURES

In the drawings, closely related figures share the same numbers, with different alphabetic suffixes.

FIG. 1. View of the robotic system for scrap bundling.

FIG. 2. View of the robotic system for scrap bundling.

FIG. 3. View of a layout of the robotic system for scrap bundling.

### DRAWINGS—REFERENCE NUMERALS

1. Robotic manipulator
2. Gripping mechanism
3. Copper scrap
4. Feeding system
5. Copper scrap arrange

### DETAILED DESCRIPTION

This invention relates to a new robot system as well as a robotic method for scrap bundling, which automatically arranges the scrap bundles using an anthropomorphous robotic arm of at least 6 degrees of freedom.

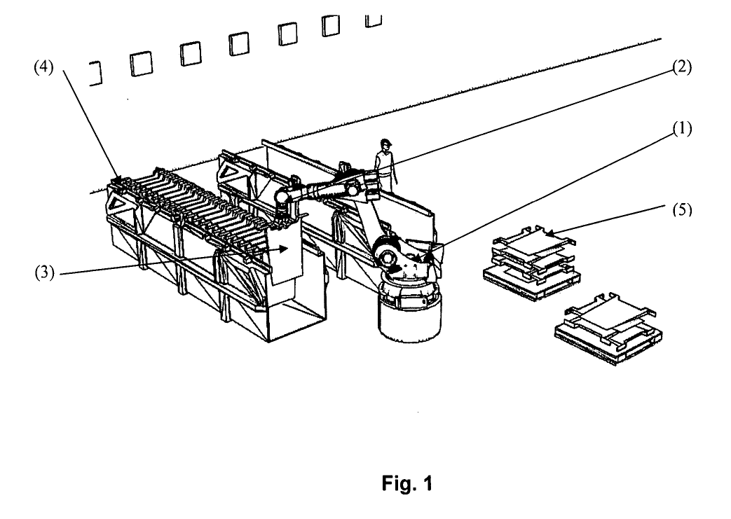

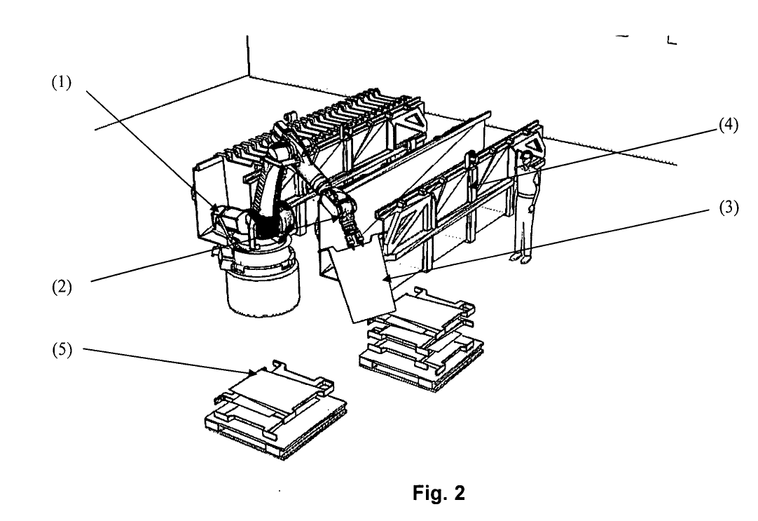

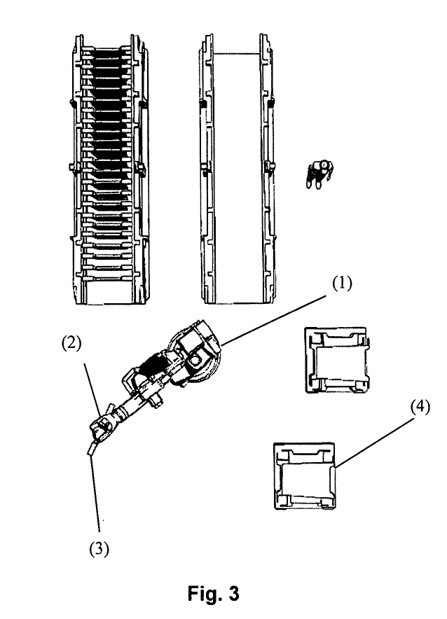

With reference to FIG. 1, FIG. 2, and FIG. 3, the robotic system for scrap bundling is composed mainly of one anthropomorphous robotic manipulator of at least 6 degrees of freedom (1) provided with a communication, acquisition and control system, a gripping mechanism (2) to take the scrap (3) from a feeding system (4) located at one of its sides and moves it through a predefined path to the bundling area, in which the scrap is released (5) in an arranged manner to bundle the scraps (5)

I claim:

1. A robot system for scrap bundling in metal smelting and refining processes comprising an anthropomorphous robotic arm of at least 5 degrees of freedom, one control, communication and programming unit, one gripper adapter, one pneumatic gripper, its fingers, one pneumatic gripper driving system, one electric supply system and two mobile feeding drawer racks with a driving system wherein the anthropomorphous robotic arm of at least 5 degrees of freedom is provided with a gripping mechanism which allows to take the scrap from one mobile drawer rack and moves it through a defined path to the bundling area, in which, bundles are assembled in a sequential and programmed way as they are removed from the racks.

2. A robot system for scrap bundling in metal smelting and refining processes according to claim 1, wherein the system has the capacity to take, manipulate and release the scrap in different paths within the work volume of the robot system.

3. A robot system for scrap bundling in metal smelting and refining processes according to claim 1, wherein the anthropomorphous robotic arm of at least 5 degrees of freedom is mounted on a fixed and/or mobile support located between the mobile drawer racks and the scrap bundles.

4. A robot system for scrap bundling in metal smelting and refining processes according to claim 1, wherein the anthropomorphous robotic manipulator could communicate by itself or through a PLC interface.

5. A robot system for scrap bundling in metal smelting and refining processes according to claim 1, wherein the anthropomorphous robotic manipulator has the capacity to obtain and interpret the information from installed analogue and/or digital sensors.

6. A robot system for scrap bundling in metal smelting and refining processes according to claim 1, wherein the anthropomorphous robotic manipulator has the capacity to generate analogue and/or digital signals to control analogue and/or digital input devices.

7. A robot system for scrap bundling in metal smelting and refining processes according to claim 1, wherein the robotic manipulator has a pneumatic gripping mechanism which allows to take, manipulate and release the scrap.

8. A robot system for scrap bundling in metal smelting and refining processes according to claim 1, wherein a pneumatic gripping mechanism with at least 4 fingers is provided for grasping and releasing the scrap.

9. A robot system for scrap bundling in metal smelting and refining processes according to claim 1, wherein the anthropomorphous robotic manipulator has an electrical system driven by three-stage induction motors with vectorial and/or scalar control.

10. A robot system for scrap bundling in metal smelting and refining processes according to claim 1, wherein two drawer racks are used, which move out of the work volume of the robot to be filled with scrap by a forklift or any other machinery.

11. A robot system for scrap bundling in metal smelting and refining processes according to claim 1, wherein productivity and efficiency of scrap bundling in electrometallurgical processes of different metals increases.

12. A robot system for scrap bundling in metal smelting and refining processes according to claim 1, wherein the system may operate automatically, semiautomatically, and also allows solutions scalability.

13. A robot system for scrap bundling in metal smelting and refining processes according to claim 1, wherein the system could be integrated to scrap bundling of different metals such as copper, iron, zinc, lead, etc.

14. A robot system for scrap bundling in metal smelting and refining processes according to claim 1, wherein it prevents the plant personnel from being subjected to a high physical demand and harsh environmental conditions.

15. A robotic method for scrap bundling in metal smelting and refining processes using the robot System of claim N^{o}1 to N^{o}14, wherein the anthropomorphous robotic arm of at least 5 degrees of freedom is provided with a gripping mechanism to take the scrap from one of the mobile drawer racks and moves it through a defined path to the bundling area, where scrap bundles are arranged in a sequential and programmed way as the scrap is removed from the racks.

16. A robotic method for scrap bundling in metal smelting and refining processes using the robot System of claim N^{o}1 to N^{o}14, wherein the manipulator has the capacity to take, manipulate and release the scrap in different paths within the work volume of the robotic system.

17. A robotic method for scrap bundling in smelting and refining processes using the robot System of claim N^{o}1 to N^{o}14, wherein the anthropomorphous robotic arm of at least 5 degrees of freedom is mounted on a fixed and/or mobile support located between the mobile drawer racks and the scrap bundles.

18. A robotic method for scrap bundling in metal smelting and refining processes using the robot System of claim N^{o}1 to N^{o}14, wherein the anthropomorphous robotic manipulator could communicate by itself or through a PLC interface.

19. A robotic method for scrap bundling in metal smelting and refining processes using the robot System of claim N^{o}1 to N^{o}14, wherein the anthropomorphous robotic manipulator has the capacity to obtain and interpret the information from installed analogue and/or digital sensors.

20. A robotic method for scrap bundling in metal smelting and refining processes using the robot System of claim N^{o}1 to N^{o}14, wherein the anthropomorphous robotic manipulator has the capacity to generate analogue and/or digital signals to drive the analogue and/or digital inputs devices.

21. A robotic method for scrap bundling in metal smelting and refining processes using the robot System of claim N^{o}1 to N^{o}14, wherein a pneumatic gripper to take, manipulate and release the scrap is used.

22. A robotic method for scrap bundling in metal smelting and refining processes using the robot System of claim N^{o}1 to N^{o}14, wherein a pneumatic gripping mechanism is provided with at least 4 fingers for grasping and releasing the scrap.

23. A robotic method for scrap bundling in metal smelting and refining processes using the robot System of claim N^{o}1 to N^{o}14, wherein the anthropomorphous robotic manipulator has an electrical system driven by three-stage induction motors with vectorial and/or scalar control.

24. A robotic method for scrap bundling in metal smelting and refining processes using the robot System of claim N^{o}1 to N^{o}14, wherein two mobile drawer racks are used, which move out of the work volume of the robot to be filled with scrap by a forklift or any other machinery.

25. A robotic method for scrap bundling in metal smelting and refining processes using the robot System of claim N^{o}1 to N^{o}14, wherein productivity and efficiency of scrap bundling in electrometallurgical processes of different metals increases.

26. A robotic method for scrap bundling in metal smelting and refining processes using the robot System of claim N^{o}1 to N^{o}14, wherein the system may operate automatically or semiautomatically, and also allows solution scalability.

27. A robotic method for scrap bundling in smelting and refining processes using the robot System of claim N^{o}1 to N^{o}14, wherein the system could be integrated to the scrap bundling process of different metals such as copper, iron, zinc, lead, etc.

28. A robotic method for scrap bundling in metal smelting and refining processes using the robot System of claim N^{o}1 to N^{o}14, wherein it prevents the plant personnel from being subjected to a high physical demand and harsh environmental conditions.
